(19) United States
(12) Patent Application Publication
(10) Pub. No.: US 2018/0236673 A1
(43) Pub. Date: Aug. 23, 2018

(54) GROOMING HAIR TRIMMER

(71) Applicant: Ornata LLC, Los Angeles, CA (US)

(72) Inventor: Gregory Hoffmann, Danbury, CT (US)

(73) Assignee: Ornata LLC, Los Angeles, CA (US)

(21) Appl. No.: 15/440,978

(22) Filed: Feb. 23, 2017

(51) Int. Cl. B26B 19/20; B26B 19/06; B26B 19/38

(52) U.S. Cl. CPC B26B 19/20; B26B 19/3873; B26B 19/3853; B26B 19/06

(57) ABSTRACT

A hair trimmer is provided that includes a housing having a proximal and a distal portion, a motor-driven cutting blade disposed on the proximal portion of the housing and an actuating cutting guard disposed on the proximal portion of the housing. The actuating cutting guard is configured to move between a disengaged position and an engaged position with respect to the cutting blade. When in the disengaged position, the cutting guard is housed within the housing and positioned away from the cutting blade. When in the engaged position, the cutting guard is positioned near the cutting blade and configured to prevent a predetermined length of hair from contacting the cutting blade. The hair trimmer may also include an adjusting member configured to move the cutting guard between the disengaged and engaged positions.

### FIELD

The present invention generally relates to hair trimmers, and more particularly to a hair trimmer with an independently actuating cutting guard.

### BACKGROUND

Conventionally, hair trimming appliances utilize a stationary shearing blade fixed to a stationary base of a clipper and a movable cutting blade, both blades being provided with teeth and cooperating with each other upon reciprocating movement of the movable blade to cut hair. To control the length of hair that may be cut in a given cutting pass, removable cutting guards may be used to guard or protect a certain length of hair from reaching the cutting blades. The cutting guards are positioned adjacent to the cutting blades and arranged so that they shield a predetermined length of hair from the cutting blades.

Cutting guards are available in varying sizes that correspond to the length of hair each is intended to protect. Typically such length ranges from 1/16 of an inch to 1 inch. For example, a cutting guard having a designation of “0” may protect a length of hair measuring approximately 1/16 of an inch. By way of another example, a cutting guard having a designation of 4 may protect a length of hair measuring approximately ½ of an inch. And by way of yet another example, a cutting guard having a designation of 8 may protect a length of hair measuring approximately 1 inch.

A user wishing to use a hair trimming appliance with capabilities of cutting hair at varying lengths will therefore have to use multiple interchangeable cutting guards to achieve their desired result.

### SUMMARY

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

According to various aspects of the subject technology, a hair trimmer is provided. The hair trimmer comprises A hair trimmer comprises a housing having a proximal and a distal portion, a motor-driven cutting blade disposed on the proximal portion of the housing and an actuating cutting guard disposed on the proximal portion of the housing. The cutting guard is configured to move between a disengaged position and an engaged position with respect to the cutting blade. When the cutting guard is in the disengaged position, the cutting guard is housed within the housing and positioned away from the cutting blade. When in the engaged position, the cutting guard is positioned near the cutting blade and configured to prevent a predetermined length of hair from contacting the cutting blade. The hair trimmer also comprises an adjusting member configured to move the cutting guard between the disengaged and engaged positions.

In accordance with one aspect of the subject technology, a method for assembling a hair trimmer that has a movable cutting guard is provided. The method comprises mounting a motor-driven cutting blade onto a proximal end of a housing of the hair trimmer; sliding a cutting guard onto a guide disposed within the housing, the guide extending along a longitudinal axis extending through the proximal end and a distal end of the housing. When in a first position, the cutting guard is housed within the housing and positioned away from the cutting blade. When in a second position, the cutting guard is positioned near the cutting blade and configured to prevent a predetermined length of hair from contacting the cutting blade. The method further comprises connecting an adjustment member to the cutting guard such that actuation of the adjustment member causes the cutting guard to move between the first and second positions.

Additional features and advantages of the subject technology will be set forth in the description below, and in part will be apparent from the description, or may be learned by practice of the subject technology. The advantages of the subject technology will be realized and attained by the structure particularly pointed out in the written description and claims hereof as well as the appended drawings.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The accompanying drawings, which are included to provide further understanding of the subject technology and are incorporated in and constitute a part of this specification, illustrate aspects of the subject technology and together with the description serve to explain the principles of the subject technology.

FIG. 1 depicts a perspective view of a hair trimmer with a cutting guard in a disengaged position, in accordance with various aspects of the subject technology.

FIG. 2 depicts a perspective view of a hair trimmer with a cutting guard in an engaged position, in accordance with various aspects of the subject technology.

FIG. 3 depicts a perspective view of a hair trimmer, in accordance with various aspects of the subject technology.

FIG. 4A depicts a top view of a hair trimmer with a cutting guard in a disengaged position, in accordance with various aspects of the subject technology.

FIG. 4B depicts a top view of a hair trimmer with a cutting guard in an engaged position, in accordance with various aspects of the subject technology.

FIG. 4C depicts a bottom view of a hair trimmer, in accordance with various aspects of the subject technology.

FIG. 5A depicts a front view of a hair trimmer with a cutting guard in an engaged position, in accordance with various aspects of the subject technology.

FIG. 5B depicts a side view of a hair trimmer with a cutting guard in an engaged position, in accordance with various aspects of the subject technology.

FIG. 6A depicts a front view of a hair trimmer with a first and second cutting guard in an engaged position, in accordance with various aspects of the subject technology.

FIG. 6B depicts a side view of a hair trimmer with a first and second cutting guard in an engaged position, in accordance with various aspects of the subject technology.

FIG. 7 depicts a perspective view of a hair trimmer with a first and second cutting guard in an engaged position, in accordance with various aspects of the subject technology.

FIG. 8 illustrates an example method for using a hair trimmer with actuating cutting guards, in accordance with various aspects of the subject technology.

FIG. 9 illustrates an example method for assembling a hair trimmer having a movable cutting guard, in accordance with various aspects of the subject technology.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be apparent to those skilled in the art that the subject technology may be practiced without these specific details. In some instances, well-known structures and components have not been shown in detail so as not to obscure the subject technology.

Conventionally, motor-driven hair trimming devices utilize a reciprocating cutting blade to cut or trim hair. To control the length of hair that may be cut in a given cutting pass, removable cutting guards are used to guard or protect a certain length of hair from reaching the cutting blade. The cutting guards are generally slid into place and designed to protect a predetermined length of hair from reaching the cutting blades.

Cutting guards are typically designed to protect a specific length of hair from the cutting blades and are identified with a numerical identifier to convey to a user, the length of hair a certain cutting guard with a certain identifier is designed to protect. For example, a cutting guard having a designation of “0” may protect a length of hair measuring approximately 1/16 of an inch. By way of another example, a cutting guard having a designation of 4 may protect a length of hair measuring approximately ½ of an inch. And by way of yet another example, a cutting guard having a designation of 8 may protect a length of hair measuring approximately 1 inch. Cutting guards are therefore available in varying sizes with each size corresponding to a specific length of hair that a particular cutting guard is designed to protect. A user wishing to use a hair trimming device with capabilities of cutting hair at varying lengths will therefore have to use multiple interchangeable cutting guards to achieve their desired result. In addition, requiring the use of multiple cutting guards increases the probability that a certain guard may be misplaced, lost or damaged.

The hair trimmer of the subject technology solves some or all of the foregoing problems by using an integrated actuating cutting guard that is configured to be moved to a plurality of positions to prevent hair with differing lengths from reaching the cutting blades. In some embodiments the actuating cutting guard may be stowed within the housing to prevent damage to the cutting guard and to eliminate the probability that the cutting guard be misplaced or lost. In some embodiments, an adjusting member is provided that moves the cutting guard to each of the plurality of positions. In other embodiments, an indicator on the hair trimmer is provided to inform the user of which position of the plurality of positions the cutting guard is set to, such that a user understands the length of hair the cutting guard is capable of protecting from the cutting blades. In certain such embodiments, a second actuating cutting guard is also provided for protecting a predetermined length of hair reaching the cutting blades.

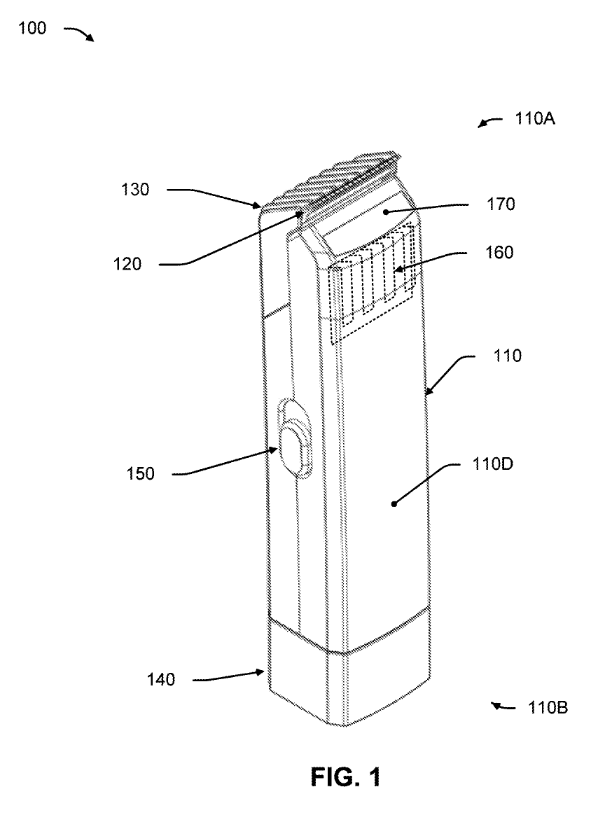

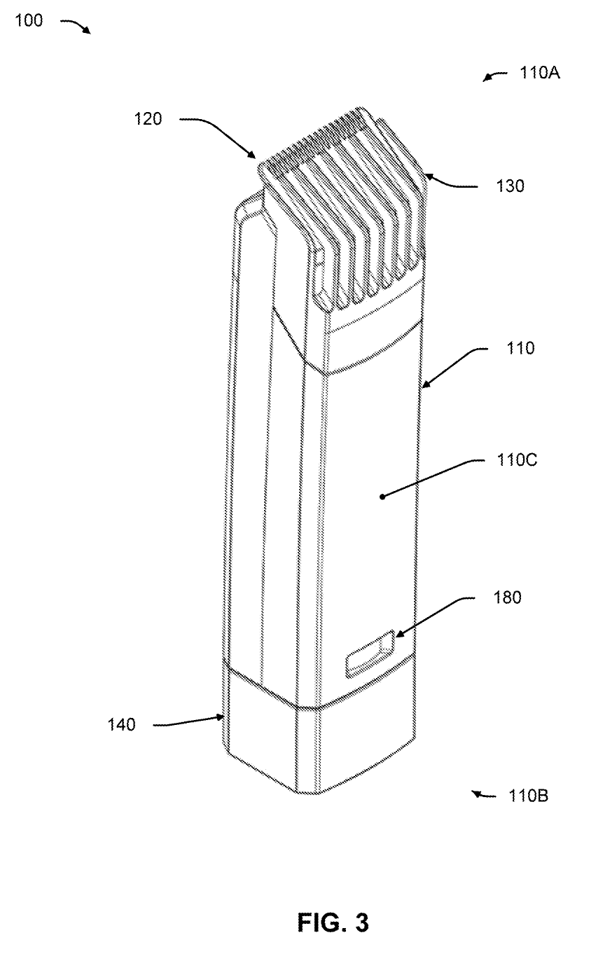

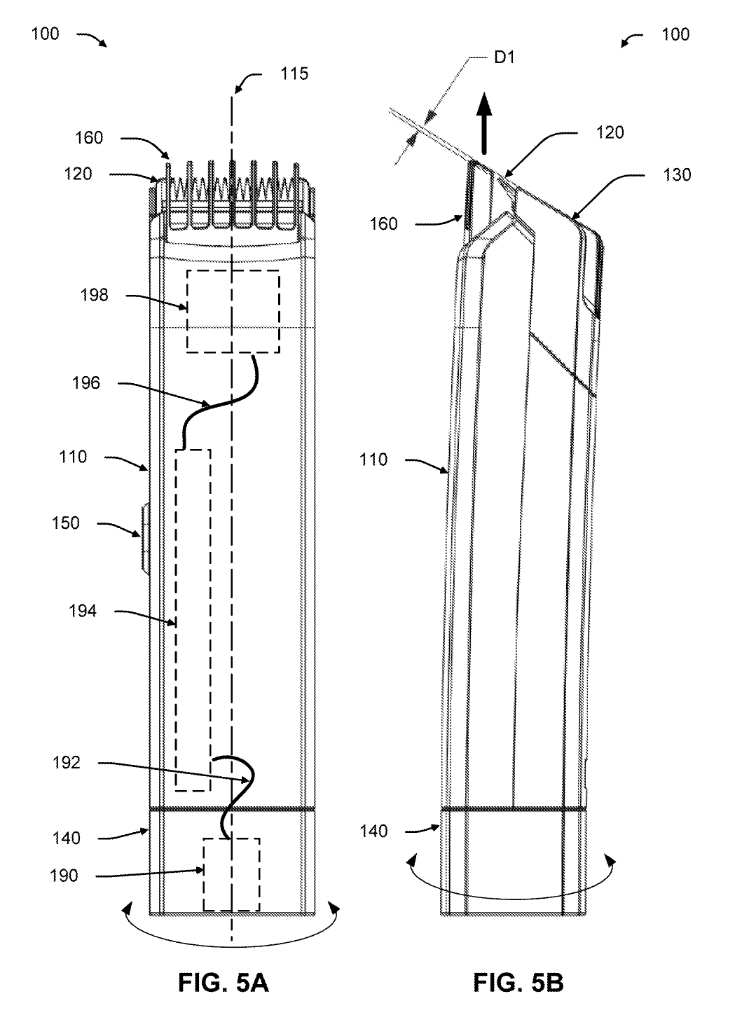

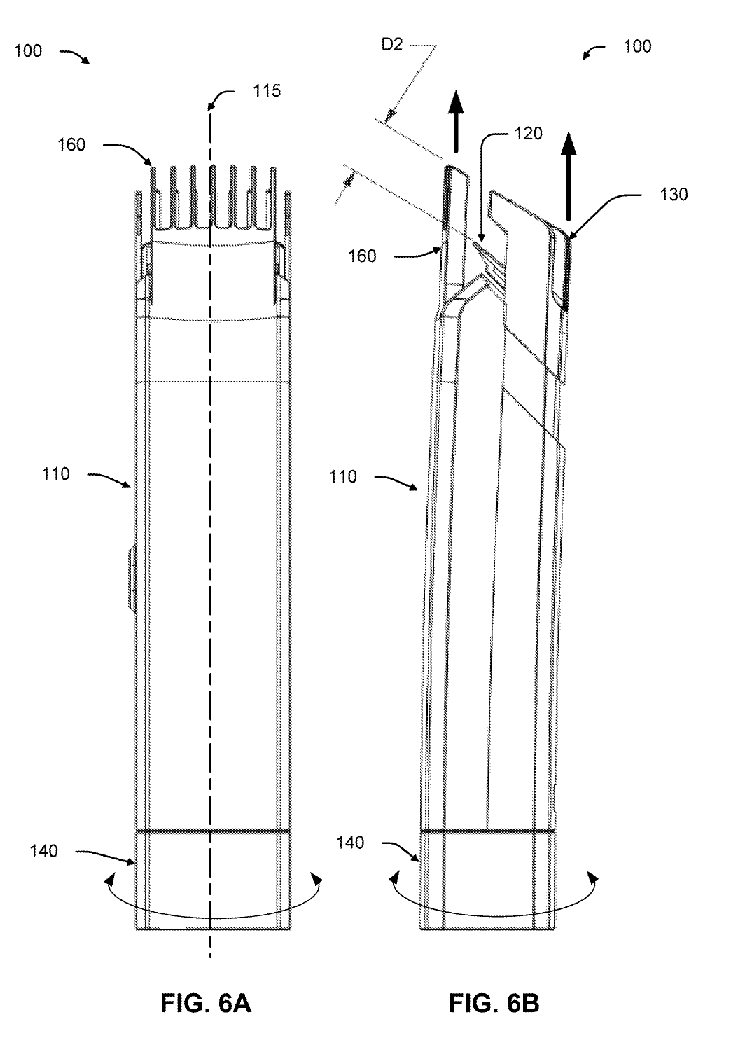

FIG. 1 depicts a perspective view of a hair trimmer 100 with an actuating cutting guard 160 in a disengaged position, in accordance with various aspects of the subject technology. The hair trimmer 100 comprises a housing 110 having a proximal portion 110A and a distal portion 110B. The housing 110 may be manufactured of plastic, composite material, metal, or a combination thereof, and is configured to house internal components of the hair trimmer 100. The housing 110 has a top surface at the proximal portion 110A, a bottom surface opposite the top surface at the distal portion 110B, a front surface 110C (as shown in FIG. 3), a rear surface 110D opposite the front surface, side walls, and a longitudinal axis 115 (as shown in FIGS. 5A and 6A) extending through the top and bottom surfaces of the housing 110. The hair trimmer 100 utilizes a motor-driven cutting blade 120 disposed on the proximal portion 110A of the housing 100. The cutting blade 120 may comprise a first reciprocating cutting blade that cooperates with a second stationary blade. The cutting blade may be manufactured from stainless steel, alloys, or other hardened materials as may be known by a person of ordinary skill.

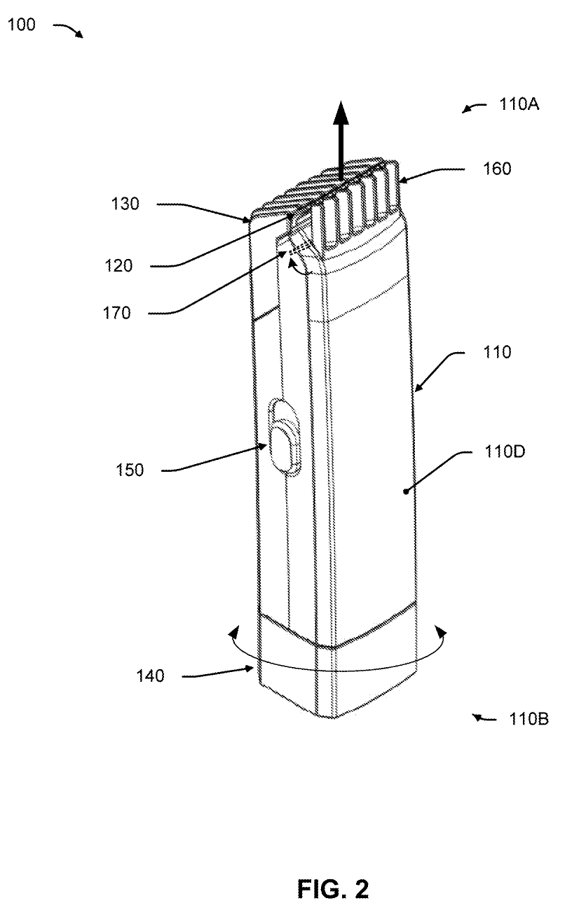

FIG. 2 depicts a perspective view of the hair trimmer 100 with the actuating cutting guard 160 in an engaged position. The actuating cutting guard 160 is disposed on the proximal portion 110A of the housing 110 and configured to move between a disengaged position (as shown in FIG. 1) and an engaged position (as shown in FIG. 2) with respect to the cutting blade 120. In some aspects, movement of the actuating cutting guard 160 between the disengaged and engaged positions may be accomplished by use of a guide, rail, track, or other mechanical components as understood by a person of ordinary skill. By way of example, a linear slot may be provided within the housing 110 that is configured to receive a corresponding protrusion on the actuating cutting guard 160. The linear slot and protrusion cooperate to guide the actuating cutting guard 160 between the disengaged and engaged positions. In one aspect, the actuating cutting guard 160 is configured to slide along a plane between the disengaged and engaged positions.

As shown in FIG. 2, when the actuating cutting guard 160 is in the engaged position, the actuating cutting guard 160 is positioned near the cutting blade 120 and configured to prevent a predetermined length of hair from contacting the cutting blade 120. Specifically, the actuating cutting guard 160 may comprise a plurality of longitudinal members that are configured to prevent a predetermined length of hair from making contact with the cutting blades 120, as discussed further below.

Referring to FIG. 1, in some aspects when the actuating cutting guard 160 is in the disengaged position, the actuating cutting guard 160 may be housed or stowed completely within the housing 110. In the disengaged position, the actuating cutting guard 160 is positioned furthest away from the cutting blade 120. In some aspects, stowing the actuating cutting guard 160 within the housing 110 prevents damage to the cutting guard 160 and eliminates the possibility that the cutting guard 160 may be misplaced or lost.

The hair trimmer 100 may further comprise a flap 170 disposed at the proximal portion 110A of the housing 110 that is configured to conceal or fully enclose the actuating cutting guard 160 within the housing 110 when the actuating cutting guard 160 is in the disengaged position. The flap 170 may be configured to move and create an opening on the housing 110 (as shown in FIG. 2) to thereby allow the actuating cutting guard 160 to move between the disengaged position (as shown in FIG. 1), to the engaged position (as shown in FIG. 2). For example, the flap 170 may be pivotably coupled to the housing 110 and configured to pivot between a first position where the flap 170 conceals the actuating cutting guard 160 (as shown in FIG. 1), to a second position where the flap 170 rotates along an axis to create an opening in the housing 110 to allow the actuating cutting guard 160 to move to the engaged position (as shown in FIG. 2). In another example, the flap 170 may be disposed on a track on the housing 110 that is configured to allow the flap 170 to move between the first and second positions. In another aspect, the flap 170 may move between the first and second positions automatically, by use, for example, of a torsion spring, lever, or other actuating device as would be known by a person of ordinary skill in the art. In particular, the flap 170 may utilize a torsion spring to automatically actuate the flap 170 to the first, concealing, position. To automatically open the flap 170, the flap 170 may be mechanically linked to the actuating cutting guard 160 such that movement of the actuating cutting guard 160 to the engaged position causes the flap 170 to compress the torsion spring through use of mechanical levers and/or cams. The flap 170 may be manufactured from the same material as the housing 110.

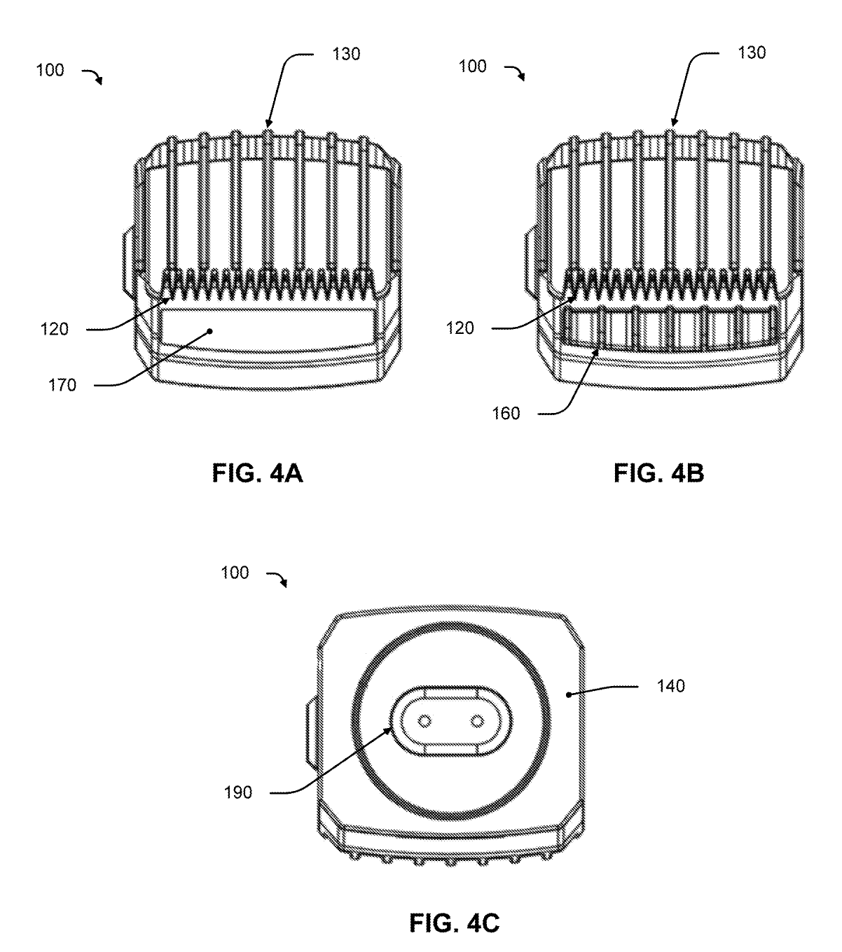

Referring to FIG. 2, the hair trimmer 100 may also comprise an adjusting member 140 configured to move the cutting guard 160 between the disengaged and engaged positions. The adjusting member 140 may comprise a rotating member disposed at the distal portion 110B of the housing 110. The adjusting member 140 may be configured to move the actuating cutting guard 160 proximally or distally with respect to the housing 110 as the adjusting member 140 is rotated. For example, rotating the adjusting member 140 to a rotation angle of 180 degrees may cause the actuating cutting guard 160 to move 1/10 of an inch either proximally or distally with respect to the housing 110, depending on the rotational direction of the adjusting member 140. By way of another example, the adjusting member 140 may be configured so that clockwise rotation of the adjusting member 140 causes the actuating cutting guard 160 to move proximally with respect to the housing 110. Similarly, counter-clockwise rotation of the adjusting member 140 may cause the actuating cutting guard 160 to move distally with respect to the housing 110. In some aspects, actuation of the actuating cutting guard 160 through rotation of the adjusting member 140 may be accomplished mechanically through use of a threaded spindle, rod, or other mechanical components as would be understood by a person of ordinary skill. Referring to FIG. 4C, the adjusting member 140 may also include a hallowed portion that is configured to receive a charging port 190 (as discussed further below).

Referring to FIG. 3, the hair trimmer 100 may further comprise an indicator 180 disposed on the front surface 110C of the housing 110. The indicator 180 is configured to identify the position of the actuating cutting guard 160 with respect to the cutting blade 120. For example, if the actuating cutting guard 160 is positioned to protect a length of hair measuring approximately 1/16 of an inch from contacting the cutting blades 120, the indicator 180 may display “0”. If the actuating cutting guard 160 is positioned to protect a length of hair measuring approximately ¼ of an inch from contacting the cutting blades 120, the indicator 180 may display “2”. If the actuating cutting guard 160 is positioned to protect a length of hair measuring approximately ½ of an inch from contacting the cutting blades 120, the indicator 180 may display “4”.

FIG. 4A depicts a top view of the hair trimmer 100 showing the cutting blades 120 and the actuating cutting guard 160 in the disengaged position, stowed within the housing 110 and concealed by the flap 170. FIG. 4B depicts a top view of the hair trimmer 100 showing the cutting blades 120 and the actuating cutting guard 160 in the engaged position. FIG. 4C depicts a bottom view of the hair trimmer 100. In one aspect, the hair trimmer 100 may further comprise a charging port 190 disposed within the adjusting member 140, as described below.

FIG. 5A depicts a front view of the hair trimmer 100 with the actuating cutting guard 160 in the engaged position, in accordance with various aspects of the subject technology. The charging port 190 may be disposed on the distal portion of the housing 110 and electrically coupled 192 to a battery 194 to charge the battery 194. The battery 194 may be disposed entirely within the housing 110. The battery 194 is electrically coupled 196 to an internal motor 198 and configured to provide power to the motor 198. The motor 198 is configured to move the cutting blade 120 and thereby cut hair. Activation of the battery 194 and thus motor 198, may be accomplished by use of a power button 150 disposed on the housing 110.

As described above, rotation of the adjusting member 140 may cause the actuating cutting guard 160 to move proximally or distally, depending on the direction of rotation of the adjusting member 140. In one aspect, the actuating cutting guard 160 may be configured to move or slide along a plane that is substantially parallel to the longitudinal axis 115. The longitudinal axis 115 may extend through the top and bottom surfaces of the housing 110.

FIG. 5B depicts a side view of the hair trimmer 100 with the actuating cutting guard 160 in the engaged position, in accordance with various aspects of the subject technology. In one aspect, when in the engaged position, the actuating cutting guard 160 may prevent a predetermined length D1 of hair from contacting the cutting blade 120. The predetermined length D1 may be about 0.05″, 0.10″, 0.13″, 0.15″, 0.20″, 0.25″, 0.30″, 0.35″, 0.38″, 0.40″, 0.45″, 0.50″, 0.55″, 0.60″, 0.63″, 0.65″, 0.70″, 0.75″, 0.80″, 0.85″, 0.88″, 0.90″, 0.95″ or 1.00″, though other ranges are also possible.

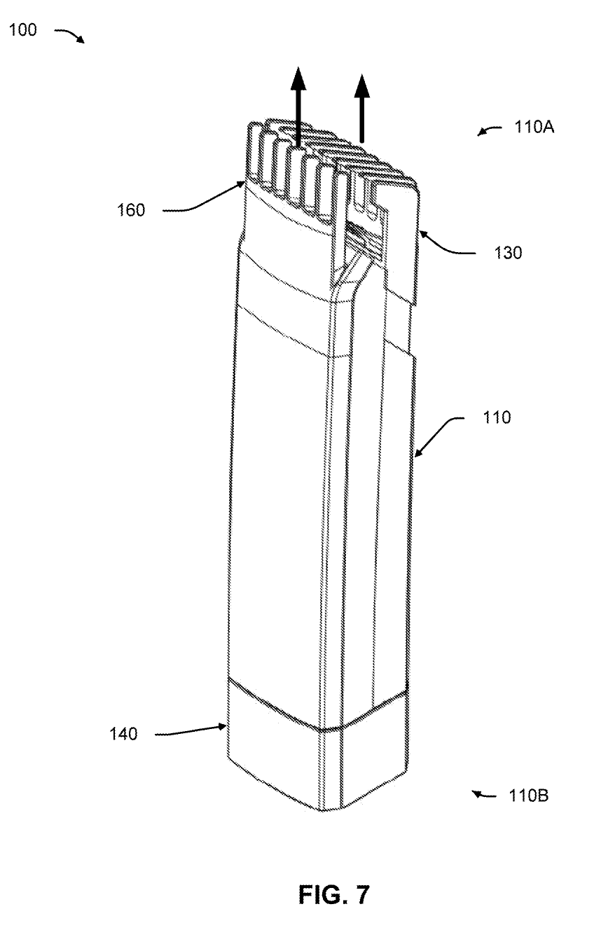

FIGS. 6A and 6B depict a front view and side view, respectively, of the hair trimmer 100 with a second actuating cutting guard 130 in a second engaged position, in accordance with various aspects of the subject technology. The hair trimmer 100 may further comprise a second actuating cutting guard 130 disposed on the proximal portion 110A of the housing 110. The second actuating cutting guard 130 may comprise a plurality of longitudinal members that are configured to prevent a predetermined length of hair from making contact with the cutting blades 120. In some aspects, the second actuating cutting guard 130 may be configured to slide along a track disposed on the housing 110 to move between a first engaged position (as shown in FIGS. 1-4B, 5A and 5B) and a second engaged position (as shown in FIGS. 6A-7) with respect to the cutting blade 120. By way of one example, the track may be an integral component of the exterior surface of the housing 110. By way of another example, the track may comprise a slot through the housing 110 that is configured to receive a corresponding protrusion from the second actuating cutting guard 130. Other mechanisms may be used achieve the desired result, as would be understood by a person of ordinary skill in the art.

In one aspect, the second actuating cutting guard 130 may be configured to move or slide along a plane that is substantially parallel to the longitudinal axis 115. In another aspect, the second actuating cutting guard 130 may slide along a plane that is substantially parallel to the plane that the actuating cutting guard 160 slides along (as described above).

In one aspect, the position of the second actuating cutting guard 130 may be adjusted manually. For example, a user may adjust the position of the actuating cutting guard 160 by rotating adjusting member 140 and then adjust the position of the second actuating cutting guard 130 by manually sliding the second actuating cutting guard 130 to a desired position. In this example, the actuating cutting guard 160 and the second actuating cutting guard 130 are independently actuated.

In another aspect, the position of the second actuating cutting guard 130 may be adjusted in tandem with the actuating cutting guard 160 so that adjustment of one, cutting guard causes adjustment of the other cutting guard. Specifically, as described above, rotation of the adjusting member 140 may cause actuating cutting guard 160 and the second actuating cutting guard 130 to move in a coordinated fashion, proximally or distally with respect to the housing 110, to a desired position. In this example, the adjusting member 140 may be configured to move the actuating cutting guard 160 between the disengaged position (as shown in FIG. 1) and the engaged position (as shown in FIG. 2), and move the second actuating cutting guard 130 between the first engaged position (as shown in FIG. 5B) and the second engaged position (as shown in FIG. 6B). In some aspects, actuation of the actuating cutting guard 160 and the second actuating cutting guard 130 through rotation of the adjusting member 140 may be accomplished mechanically through use of a threaded spindle, rod, or other mechanical components as would be understood by a person of ordinary skill.

In some aspects, the actuating cutting guard 160 and the second actuating cutting guard 130 may each be configured to be positioned in a plurality of engaged positions thereby enabling the hair trimmer 100 to prevent a varying lengths of hair from contacting the cutting blades 120. Referring to FIGS. 5A and 5B, the actuating cutting guard 160 may be positioned at a first engaged position of the plurality of engaged positions, thereby preventing a first length D1 of hair from contacting the cutting blades 120. Likewise, the second actuating cutting guard 130 may also be positioned at a first engaged position of the plurality of engaged positions, thereby preventing the first length D1 of hair from contacting the cutting blades 120. The first length D1 of hair that is protected from the cutting blades may be 0.05″, 0.10″, 0.13″, 0.15″, 0.20″, 0.25″, 0.30″, 0.35″, 0.38″, 0.40″, 0.45″, 0.50″, 0.55″, 0.60″, 0.63″, 0.65″, 0.70″, 0.75″, 0.80″, 0.85″, 0.88″, 0.90″, 0.95″ or 1.00″, though other ranges are also possible.

Referring to FIGS. 6A and 6B, the actuating cutting guard 160 may be positioned at a second engaged position of the plurality of engaged positions, thereby preventing a second length D2 of hair from contacting the cutting blades 120. Likewise, the second actuating cutting guard 130 may also be positioned at the second engaged position of the plurality of engaged positions, thereby preventing the second length D2 of hair from contacting the cutting blades 120. The Second length D2 of hair that is protected from the cutting blades 120 may be 0.05″, 0.10″, 0.13″, 0.15″, 0.20″, 0.25″, 0.30″, 0.35″, 0.38″, 0.40″, 0.45″, 0.50″, 0.55″, 0.60″, 0.63″, 0.65″, 0.70″, 0.75″, 0.80″, 0.85″, 0.88″, 0.90″, 0.95″ or 1.00″, though other ranges are also possible. In some aspects, the length D2 is longer than the first length D1.

FIG. 7 depicts a perspective view of the hair trimmer 100 with the actuating cutting guard 130 and the second actuating cutting guard 130 in a second engaged position, in accordance with various aspects of the subject technology. It is understood that while two engaged positions are recited above, additional engaged positions are possible. For example, the actuating cutting guard 160 and the second actuating cutting guard 130 may be configured to protect a length of 0.13″ of hair at a first engaged position, a length of 0.25″ of hair at a second engaged position, a length of 0.38″ of hair at a third engaged position, a length of 0.50″ of hair at a fourth engaged position, a length of 0.63″ of hair at a fifth engaged position, a length of 0.75″ of hair at a sixth engaged position, a length of 0.88″ of hair at a seventh engaged position, and a length of 1.00″ of hair at an eighth engaged position. It is understood that other lengths and ranges are fully contemplated by the subject technology.

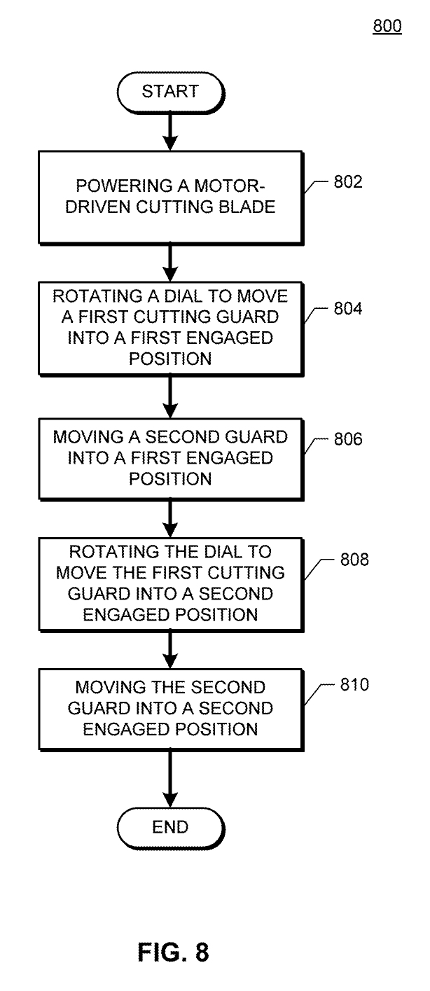

A method for using the hair trimmer 100 will now be described. FIG. 8 illustrates an example method 800 for using the hair trimmer 100 with actuating cutting guards 160, 130, in accordance with various aspects of the subject technology. First, at step 802, power to the motor is provided to drive the cutting blades 120. Next, at step 804, the adjusting member 140 is rotated to move the cutting guard 160 to the engaged position thereby preventing a predetermined length of hair from contacting the cutting blades 120. At step 806, the second cutting guard 130 is moved into the engaged position to thereby prevent a predetermined length of hair from contacting the cutting blades 120.

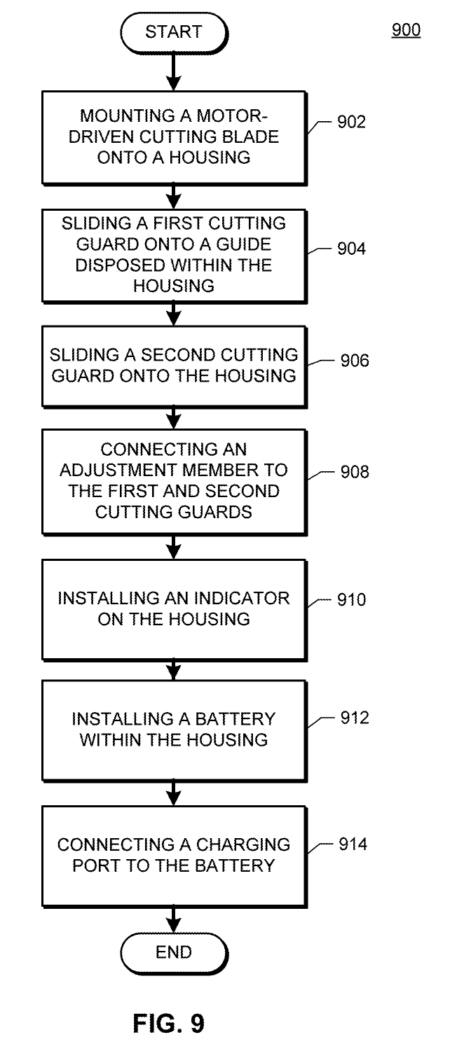

A method for assembling the hair trimmer 100 having a movable cutting guard 160 will now be described. FIG. 9 illustrates an example method 900 for assembling the hair trimmer 100 having a movable cutting guard, in accordance with various aspects of the subject technology. First, at step 902, a motor-driven cutting blade 120 is mounted onto the proximal end of the housing 110. Next, at step 904, a cutting guard 160 is slid onto a guide disposed within the housing 110, the guide extends along a longitudinal axis extending through the proximal end and a distal end of the housing. When the cutting guard 160 is in a first position, the cutting guard 160 is housed within the housing 110 and positioned away from the cutting blade 120. When in a second position, the cutting guard 160 is positioned near the cutting blade 120 and configured to prevent a predetermined length of hair from contacting the cutting blade 120. At step 906, a second cutting guard 130 is slid onto the housing 110. When the second cutting guard 130 is in a first position, the cutting guard 130 is configured to prevent a first predetermined length of hair from contacting the cutting blade. When the second cutting guard 130 is in a second position, the cutting guard 130 is configured to prevent a second predetermined length of hair from contacting the cutting blade. At step 908 an adjustment member 140 is connected to the first and second cutting guards such that actuation of the adjustment member 140 causes the first and second cutting guards to move between their respective, first and second positions. At step 910 an indicator 180 is installed on the housing 110 to identify the position of the cutting guard 160 with respect to the cutting blade 120. At step 912 a battery 194 is installed within the housing 110, connected to a motor of the cutting blade 120, and configured to provide power to the motor. At step 914 a charging port 190 is connected to the battery 194 to recharge the battery 194.

Skilled artisans may implement the described functionality in varying ways for each particular application. Various components and blocks may be arranged differently (for example, arranged in a different order, or partitioned in a different way) all without departing from the scope of the subject technology. It is understood that the specific order or hierarchy of steps in the processes disclosed is an illustration of exemplary approaches. Based upon design preferences, it is understood that the specific order or hierarchy of steps in the processes may be rearranged. Some of the steps may be performed simultaneously. The accompanying method claims present elements of the various steps in a sample order, and are not meant to be limited to the specific order or hierarchy presented.

The foregoing description is provided to enable a person skilled in the art to practice the various configurations described herein. While the subject technology has been particularly described with reference to the various figures and configurations, it should be understood that these are for illustration purposes only and should not be taken as limiting the scope of the subject technology.

There may be many other ways to implement the subject technology. Various functions and elements described herein may be partitioned differently from those shown without departing from the scope of the subject technology. Various modifications to these configurations will be readily apparent to those skilled in the art, and generic principles defined herein may be applied to other configurations. Thus, many changes and modifications may be made to the subject technology, by one having ordinary skill in the art, without departing from the scope of the subject technology.

It is understood that the specific order or hierarchy of steps in the processes disclosed is an illustration of exemplary approaches. Based upon design preferences, it is understood that the specific order or hierarchy of steps in the processes may be rearranged. Some of the steps may be performed simultaneously. The accompanying method claims present elements of the various steps in a sample order, and are not meant to be limited to the specific order or hierarchy presented.

Terms such as “top,” “bottom” “front,” “rear” and the like as used in this disclosure should be understood as referring to an arbitrary frame of reference, rather than to the ordinary gravitational frame of reference. Thus, a top surface, a bottom surface, a front surface, and a rear surface may extend upwardly, downwardly, diagonally, or horizontally in a gravitational frame of reference.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. A phrase such an embodiment may refer to one or more embodiments and vice versa.

Furthermore, to the extent that the term “include,” “have,” or the like is used in the description or the claims, such term is intended to be inclusive in a manner similar to the term “comprise” as “comprise” is interpreted when employed as a transitional word in a claim.

The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” The term “some” refers to one or more. Underlined and/or italicized headings and subheadings are used for convenience only, do not limit the subject technology, and are not referred to in connection with the interpretation of the description of the subject technology. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

What is claimed is:

1. A hair trimmer comprising:
a housing having a proximal and a distal portion;
a motor-driven cutting blade disposed on the proximal portion of the housing;
an actuating cutting guard disposed on the proximal portion of the housing; and
wherein the cutting guard is configured to move between a disengaged position and an engaged position with respect to the cutting blade;
wherein when in the disengaged position, the cutting guard is housed within the housing and positioned away from the cutting blade; and
wherein when in the engaged position, the cutting guard is positioned near the cutting blade and configured to prevent a predetermined length of hair from contacting the cutting blade;
an adjusting member configured to move the cutting guard between the disengaged and engaged positions.

2. The hair trimmer of claim 1, wherein the adjusting member comprises a rotating member disposed at the distal portion of the housing, the rotating member configured to move the cutting guard proximally or distally as the rotating member is rotated.

3. The hair trimmer of claim 1, wherein the housing further comprises a top surface at the proximal portion, a bottom surface opposite the top surface at the distal portion, a front surface, a rear surface opposite the front surface, side walls, and a longitudinal axis extending through the top and bottom surfaces of the housing; wherein the cutting guard moves along a plane that is substantially parallel to the longitudinal axis.

4. The hair trimmer of claim 3, wherein the cutting guard slides along the plane between the disengaged and engaged positions.

5. The hair trimmer of claim 1, further comprising a flap disposed at the proximal portion of the housing;
wherein the flap is configured to move between a first and second position;
wherein when in the first position, the flap is configured to conceal a portion of the cutting guard when the cutting guard is in the disengaged position; and
wherein when in the second position, the flap is configured to allow the cutting guard to move to the engaged position.

6. The hair trimmer of claim 5, wherein the flap is pivotably coupled to the housing.

7. The hair trimmer of claim 6, wherein the flap is configured to pivot between the first and second positions automatically.

8. The hair trimmer of claim 1, further comprising an indicator disposed on the housing configured to identify the position of the cutting guard.

9. The hair trimmer of claim 1, wherein the predetermined length of hair comprises 1/16 of an inch.

10. The hair trimmer of claim 1, wherein the predetermined length of hair comprises ½ of an inch.

11. The hair trimmer of claim 1, wherein the engaged position of the cutting guard comprises a plurality of engaged positions;
wherein at a first engaged position of the plurality of engaged positions, the cutting guard prevents hair having a length of about 1/16 of an inch from contacting the cutting blade; and
wherein at a second engaged position of the plurality of engaged positions, the cutting guard prevents hair having a length of about ½ of an inch from contacting the cutting blade.

12. The hair trimmer of claim 1, further comprising a battery disposed within the housing configured to provide power to the motor and a charging port disposed at the distal portion of the housing configured to electrically charge the battery.

13. The hair trimmer of claim 1, further comprising a second actuating cutting guard disposed on the proximal portion of the housing
wherein the second cutting guard is configured to move between a first engaged position and a second engaged position with respect to the cutting blade;
wherein when in the first engaged position, the second cutting guard is positioned to prevent a first length of hair from contacting the cutting blade; and
wherein when in the second engaged position, the second cutting guard is positioned to prevent a second length of hair from contacting the cutting blade.

14. A method for assembling a hair trimmer having a movable cutting guard, the method comprising:
mounting a motor-driven cutting blade onto a proximal end of a housing of the hair trimmer;
sliding a cutting guard onto a guide disposed within the housing, the guide extending along a longitudinal axis extending through the proximal end and a distal end of the housing; and
wherein when in a first position, the cutting guard is housed within the housing and positioned away from the cutting blade; and
wherein when in a second position, the cutting guard is positioned near the cutting blade and configured to prevent a predetermined length of hair from contacting the cutting blade;
connecting an adjustment member to the cutting guard, wherein actuation of the adjustment member causes the cutting guard to move between the first and second positions.

15. The method of claim 14, further comprising installing an indicator on the housing, the indicator configured to identify the position of the cutting guard.

16. The method of claim 14, wherein the predetermined length of hair comprises 1/16 of an inch.

17. The method of claim 14, wherein the predetermined length of hair comprises ½ of an inch.

18. The method of claim 14, wherein when in the second position, the cutting guard prevents hair having a length of about 1/16 of an inch from contacting the cutting blade; and wherein when in a third position, the cutting guard prevents hair having a length of about ½ of an inch from contacting the cutting blade.

19. The method of claim 14, further comprising inserting a battery within the housing, the battery configured to provide power to the motor and connecting a charging port to the battery, the charging port configured to recharge the battery.

20. The method of claim 14, further comprising sliding a second cutting guard onto the housing.
